(19) United States
(12) Patent Application Publication
(10) Pub. No.: US 2009/0002558 A1
(43) Pub. Date: Jan. 1, 2009

(54) THREE-FRAME MOTION ESTIMATOR FOR RESTORATION OF SINGLE FRAME DAMAGES

(75) Inventor: Fredrik Lidberg, Sundbyberg (SE)

Correspondence Address: CONNOLLY BOVE LODGE & HUTZ LLP, 1875 EYE STREET, N.W., SUITE 1100, WASHINGTON, DC, 20006, US

(73) Assignee: DIGITAL VISION AB, Solna (SE)

(21) Appl. No.: 11/771,420

(22) Filed: Jun. 29, 2007

(51) Int. Cl. H04N 5/00; H04N 5/14

(52) U.S. Cl. 348/607; 348/699; 348/E05.001

(57) ABSTRACT

A method for reconstructing damaged areas in a single frame of digital motion pictures, where damaged pixels in a current frame (C) are reconstructed using motion compensation based on a motion estimator. The motion estimator comprises a motion vector selection using a combined measure for evaluating linear motion over three frames, going from a previous frame (P) to a next frame (N) through the current frame (C). Compared to a virtual frame motion estimator, the method according to the invention achieves better stability and confidence in the motion search. Compared to the use of a standard motion estimators, the method according to the invention has a better way of finding the correct motion for the damaged areas whether unknown or known, while still being able to find the correct motion for those parts which are not damaged.

### TECHNICAL FIELD

The invention concerns restoration of damaged single frames in motion pictures where the restoration is based on motion compensation.

### BACKGROUND

In restoration applications where a single frame is damaged by for example scratches, dirt or blotches, it is advantageous to perform temporal motion compensated reconstruction of the damaged pixels. Temporal reconstruction means that pixels in a current frame are replaced using pixels from previous and/or next frames. Using a motion estimator, the motion of objects can be determined and thus motion compensate the previous and next frames such that objects are aligned at the same pixel coordinates as the current frame.

Apart from actual motion compensated damage repair, motion estimation is also useful in damage detection in order to limit false detection, where otherwise uncompensated motion of objects could erroneously be detected as damages (to be repaired).

For the motion estimation, it is possible to use a standard motion estimator, such as described in U.S. Pat. No. 5,557,341, to produce motion vectors that describe the motion from one source frame to another, e.g. from the current frame to the previous or next frame. Two motion estimators could be utilized to have true bi-directional motion information for the current frame. In this situation, the current frame containing the damage is involved, which can be problematic when you want to find the motion at the point of the damage since the reference data is corrupted.

Another example of using a standard motion estimator is to compute motion information prior or after the current frame, i.e. to not include the current frame and motion compensate such motion data to the current frame. Such motion compensation is not trivial and is not without problems. For example, it could lead to ambiguity where several motion solutions are viable at a certain location. It could also leave holes, where no motion trajectory intersects. Two motion estimators would most certainly be necessary, one prior and one after the damaged frame and it is non-trivial to combine these to infer the motion in the current frame.

Another alternative is to use a virtual frame motion estimator, such as described in U.S. Pat. No. 4,771,331 and further enhanced in U.S. provisional application Ser. No. 60/744,628. Let's denote a current frame C containing damage to be repaired, with P and N being the previous and next frame respectively. In this application, the motion estimator would use frames P and N to generate a motion field relevant at the time of the existing frame C, without including frame C in the search. A search pattern is performed where simultaneously moving matching points in P and N are used in such a manner that all candidate vectors have a single intersection point corresponding to the current block in the frame C, see FIGS. 1 and 2. Notice how a search window with corners A-D in P is mapped to a reversed search window in N, giving a single intersection point at the reference block in the sought virtual frame C and how a search range A-B in P is mapped to a reversed search range in N with the intersection point at the reference block in the virtual frame C.

A problem with this method is that of ambiguity, where actually several motions can be found equally viable for a position in frame C. As the temporal distance between P and N is larger than between adjacent frames this will further deteriorate the quality of the motion estimation results.

### SUMMARY OF THE INVENTION

The object of the invention is a motion estimator which overcomes the above described problems. This is achieved by a three-frame motion estimator operating in such way that the virtual frame is replaced by the current frame and is included in the estimator. Compared to a virtual frame motion estimator, benefits with the method according to the invention are better stability and confidence in the motion search. Compared to the use of a standard motion estimators, the invention have a better way of finding the correct motion for the damaged areas whether unknown or known, while still being able to find the correct motion for those parts which are not damaged.

### BRIEF DESCRIPTION OF THE DRAWINGS

FIG. 1 shows a description of a virtual frame motion estimator.

FIG. 2 shows a simplified description of a virtual frame motion estimator in one dimension.

FIG. 3 shows the three reference points in P, C and N, which are used in the three frame motion estimator.

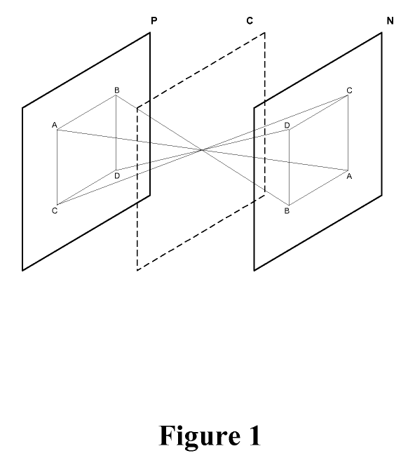

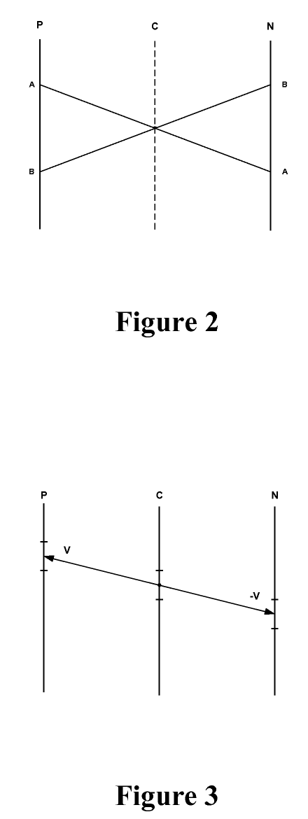

### DETAILED DESCRIPTION OF THE INVENTION

A procedure to find the best motion vector for a reference block is to find the candidate motion vector that minimizes some error function f(V). In a normal window search, the set of candidates used for evaluation could be chosen as all vectors in a search window or a sub-set of these. In a possible subsequent refining extra test phase, the set of vectors can be chosen from results (vectors) in the local neighbourhood or through global analysis (e.g. a global peak vector representing the most common motion).

Selected vector=min[f(V)]_{Vε{Candidate vectors}}

where
f(V) is the error value corresponding to a vector V describing the motion between two frames (parts thereof).

Block matching is one such commonly used procedure known to those skilled in the arts, and this procedure will be used as reference for the description of the invention. In the general case, f(V) is a sum of the absolute differences per pixel raised to a power x, where the sum of squared differences (x=2) and sum of absolute differences (x=1) are two common examples.

The invention uses a combined measure which in essence evaluates a linear motion over three frames, going from P to N, through C. This means that for a given candidate vector V, there are three reference points which are used in the evaluation, i.e. the current block in C, a relative offset in P according to vector V and a relative offset in N according to vector −V, see FIG. 3. Using these reference points an error function is created consisting of three evaluation terms corresponding to the matches between C and P, C and N as well as N and P. In mathematical terms, the best vector is found according to the following expression:

Selected vector=min[a*(f_{CP}(V)+f_{CN}(V))+b*f_{NP}(V)]_{Vε{Candidate vectors}}

where
f_{CP}(V) is the error value corresponding to motion from C to offset V in P;
f_{CN}(V) is the error value corresponding to motion from C to offset −V in N;
f_{NP}(V) is the error value corresponding to motion from offset −V in N to offset V in P;
a and b are adjustable weighting factors for balancing between error terms which include and does not include the current frame.

The invention is especially useful for finding suitable motion used for reconstruction of damaged areas whether they are small or large. Through the use of the term f_{NP}(V) it is less likely to find incorrect motion where, for instance, damages to some degree are improperly matched to actual content. By including the terms f_{CP}(V) and f_{CN}(V) it is also possible to properly consider the undamaged pixels in the current frame for improving the motion prediction of any neighboring damaged pixels. It also follows that any instability and ambiguity inherent with using only the term f_{NP}(V) is effectively reduced by this method.

The weights a and b, are used to create a balance between the error terms which include and does not include the current frame. An optimal setting will depend on the image material and type of damages, so this will usually be a user setting. It is also possible to consider a and b to be adaptive per block with regard to known damages in the block, although a below discussed improvement is better than such a method. More information on how adaptation of a and b could be implemented is described below.

With reference to block matching, the standard error function f(V) can be described as a sum of scaled differences over a window of a certain size corresponding to a block in the source frame, as follows:

$$f ( V ) = {\sum }_{( x , y ) ∈ Block in S} g ( S ( x , y ) - R ( x + {V}_{x} , y + {V}_{y} ) )$$

where
S(x,y) is a pixel in the source frame block;
R(x+Vₓ,y+V_{y}) is a pixel in the eference frame offset according to the vector V=(Vₓ,V_{y});
g(e) is a “scaling” function, e.g. abs(e) or e².

Using the terminology of current, previous and next frames, the current frame corresponds to the source frame which is partitioned into blocks of a certain width and height, where each block is assigned a motion vector. The reference frame would be either the previous or the next frame, which is used to determine the motion offset (with pixel or sub-pixel precision) for a block in the source frame. This description is useful for describing f_{CP}(V) and f_{CN}(V), and more precisely, the error functions f_{CP}(V) and f_{CN}(V) are calculated according to

$$f ( V ) = {\sum }_{( x , y ) ∈ Block in C} g ( C ( x , y ) - R ( x + {V}_{x}^{′} , y + {V}_{y}^{′} ) )$$

where
C(x,y) is a pixel in the current/source frame block;
R(x+V′ₓ,y+V′_{y}) is a pixel in the reference frame offset according to the vector V′=(V′ₓ, V′_{y}), where R and V′ corresponds to P and +V for f_{CP}(V), and N and −V for f_{CN}(V);
g(e) is a “scaling” function, e.g. abs(e) or e².

As the error function F_{NP}(V) is defined for a virtual source frame which is not included in the actual computation, that function is described slightly different as follows:

$$f ( V ) = {\sum }_{( x , y ) ∈ Block in S} g ( N ( x - {V}_{x} , y - {V}_{y} ) - P ( x + {V}_{x} , y + {V}_{y} ) )$$

where
P(x+Vₓ,y+V_{y}) is a pixel in the previous reference frame offset according to the vector V=(Vₓ,V_{y});
N(x−Vₓ,y−V_{y}) is a pixel in the next reference frame offset according to the vector −V=(−Vₓ,−V_{y}).

Taking the standard error function used to initially describe f_{CP}(V) and f_{CN}(V), the invention can be further improved by introducing prior knowledge about the damage in the current frame, in a way that damaged pixels are excluded completely or to some degree in the error functions f_{CP}(V) and f_{CN}(V).

The error functions f_{CP}(V) and f_{CN}(V) will then be modified to have the form

$$f ( V ) = {\sum }_{( x , y ) ∈ Block in S} g ( S ( x , y ) - R ( x + {V}_{x} , y + {V}_{y} ) ) * W ( x , y )$$

where
W(x,y) is a weighting factor for the individual pixels in the source/current frame

The weights applied to different pixels are in the range 0 to 1 and could be defined through user interaction or automated detection. Using actual knowledge about damaged pixels, a user can point out these damages and also tell if damaged pixels should be disregarded completely when fully damaged or only to some degree when damaged pixels contain some information which could be relevant in the motion search. An automated detection could range from simple to very complex detection procedures. A simple automation procedure for determining W(x,y) is to use a confidence profile table or function related to the intensity of pixels in the source frame. Heavy damages often show up as whitened or blacked out areas. An automation procedure could utilize this fact, by letting the weights decrease for increased brightness/blackness relative a normative central range of intensities with high confidence in non-damages. More complex damage detection procedures, could involve analysis over several frames, also including other types of motion estimation methods.

Apart from algorithmic detection procedures using visual domain data, automated detection could also involve scanning procedures analyzing infrared properties of the film to acquire knowledge about damages. The benefit of having infrared information, is that physical damages on a film are more easily detected in the infrared spectrum compared to the visible spectrum.

Using the modified error functions f_{CP}(V) and f_{CN}(V) the motion estimator can be balanced to gradually shift priority towards the f_{NP}(V) part in relation to a known or hypothesized amount of damage appearing in the current frame (at the current block in question). When “fewer” (W(x,y)<1) pixels are included from the current frame due to the detected damages, the importance of f_{NP}(V) in the final expression will increase relative f_{CP}(V) and f_{CN}(V).

The invention enables improved restoration of single frame damages. Both variations of the invention (initial and improved) can be used in manual and automated procedures for damage repair. In manual restoration, a user selects which parts of an image should be restored, and thus which areas the described three-frame motion estimator primarily should be applied to. In automated restoration, an automated detection procedure selects which areas should be repaired using the methods of the invention. The invention can further be used for repair of heavily destructed single frames (within a sequence), for instance if the major part of an image need to be restored.

It is possible to consider the methods of the invention to repair damages which are persistent over a few frames, e.g. a blotch appearing in two consecutive frames. In this case, P and N should reference the closest previous and next undamaged frames for the particular damage and C should correspond to one of the damaged frames, with vector offsets computed according to the distances between the frames P, C and N.

Case Scenario

One of many possible scenarios is one where an end-user manually determines which areas in a frame that should be restored. By manual selection, the user will create a mask representing the pixels that are undamaged or damaged (or variably damaged). To create the mask, the user could use something similar to a paint brush (of certain shape/size/intensity) or an area selection tool. The user's tool for selection could also have an adaptive nature, for instance coupled to a damage confidence profile related to pixel intensity.

In the scenario, for each brush stroke or selection the user applies in order to modify to the damage mask, the motion estimator will be invoked to compute/update a motion vector field in the local region of the current modifications. Starting from a zero vector field, a motion vector map will be continuously computed/updated according to the areas the user selects for repair. Usually a local neighborhood is also included in the motion search in order to provide stability. Using the methods described in the invention, a hierarchical motion estimator, know to those skilled in the arts, will be able to provide a very accurate motion vector field which will enable an exemplary motion compensated reconstruction of the damaged areas.

The damage mask created by the user could be used to represent the discussed pixel weighting W(x,y), if that part of the invention is used. For W(x,y), values between 0 and 1 would be used to represent pixels in a range from completely damaged to completely undamaged.

In the reconstruction phase, the damaged pixels (W(x,y)!=1) are replaced using the motion compensated pixels from the previous and next frames. The actual replacement can be performed in a number of ways, known to those skilled in the arts, but the easiest way is to replace a damaged pixel in C using the average of the corresponding pixels in P and N respectively (using motion compensation). The actual value of W(x,y) could also be included in this replacement procedure, for example similar to an alpha mix between the damaged source pixel and the reconstruction pixels in P and N.

What we claim is:

1. A method for reconstruction of damaged areas in a single frame of digital motion pictures, where damaged pixels in a current frame (C) are reconstructed using motion compensation based on a motion estimator comprising a motion vector selection using a combined measure for evaluating linear motion over three frames, going from a previous frame (P) to a next frame (N) through the current frame (C).

2. A method according to claim 1, where selection of a best motion vector for a reference block in C is based on an evaluation of each candidate vector V using three reference points, i.e. a current block's position in C, a relative offset in P according to vector V and a relative offset in N according to vector −V.

3. A method according to claim 2, where said reference points create an error function comprising three evaluation terms corresponding to the matches between C and P, C and N as well as N and P, where a best vector is found according to the expression:
Selected vector=min[a*(f_{CP}(V)+f_{CN}(V))+b*f_{NP}(V)]_{Vε{Candidate vectors}}
where
f_{CP}(V) is an error function corresponding to the motion from C to offset Vin P;
f_{CN}(V) is an error function corresponding to the motion from C to offset −V in N;
f_{NP}(V) is an error function corresponding to the motion from offset −V in N to offset V in P;
a and b are adjustable weighting factors for balancing between error terms which include and does not include the current frame.

4. A method according to claim 3, where error functions f_{CP}(V) and f_{CN}(V) are calculated according to
$$f ( V ) = {\sum }_{( x , y ) ∈ Block in C} g ( C ( x , y ) - R ( x + {V}_{x}^{′} , y + {V}_{y}^{′} ) )$$
where
C(x,y) is a pixel in the current/source frame block;
R(x+V′ₓ,y+V′_{y}) is a pixel in the reference frame offset according to the vector V′=(V′ₓ,V′_{y}), where R and V′ corresponds to P and +V for f_{CP}(V), and N and −V for f_{CN}(V);
g(e) is a “scaling” function;
and f_{NP}(V) is calculated according to
$$f ( V ) = {\sum }_{( x , y ) ∈ Block in C} g ( N ( x - {V}_{x} , y - {V}_{y} ) - P ( x + {V}_{x} , y + {V}_{y} ) )$$
where
P(x+Vₓ,y+V_{y}) is a pixel in the previous reference frame offset according to the vector V=(Vₓ,V_{y});
N(x−Vₓ,y−V_{y}) is a pixel in the next reference frame offset according to the vector −V=(−Vₓ,−V_{y}).

5. A method according to claim 4, where said scaling functions g(e) is calculated as the absolute of e raised to a power x, where x is a positive number.

6. A method according to claim 5, where said power x is 1, which corresponds to the error functions f (in claim 4) being the commonly known sum of absolute differences.

7. A method according to claim 5, where said power x is 2, which corresponds to the error functions f (in claim 4) being the commonly known sum of squared differences.

8. A method according to claim 2, where said reference points create an error function comprising three evaluation terms corresponding to the matches between C and P, C and N as well as N and P, where damages in the frame C are first identified and then utilized in error functions involving C, and where a best vector is found according to the expression:
Selected vector=min[a*(f_{CPW}(V)+f_{CNW}(V))+b*f_{NP}(V)]_{Vε{Candidate vectors}}
where
f_{CPW}(V) is an error function corresponding to the motion from C to offset Vin P, which utilizes damage information in C (symbolized by w);
f_{CNW}(V) is an error function corresponding to the motion from C to offset −V in N, which utilizes damage information in C (symbolized by w);
f_{NP}(V) is an error function corresponding to the motion from offset −V in N to offset V in P;
a and b are adjustable weighting factors for balancing between error terms which include and does not include the current frame.

9. A method according to claim 8, where error functions f_{CPW}(V) and f_{CNW}(V) are described as a weighted sum of scaled pixel differences according to
$$f ( V ) = {\sum }_{( x , y ) ∈ Block in C} g ( C ( x , y ) - R ( x + {V}_{x}^{′} , y + {V}_{y}^{′} ) ) * W ( x , y )$$
where
C(x,y) is a pixel in the current/source frame block;
R(x+V′ₓ,y+V′_{y}) is a pixel in the reference frame offset according to the vector V′=(V′ₓ, V′_{y}), where R and V′ corresponds to P and +V for f_{CPW}(V), and N and −V for f_{CNW}(V);
W(x,y) is a weighting factor for the individual pixels in the current/source frame related to damage information in frame C;
g(e) is a “scaling” function;
and f_{NP}(V) is calculated according to
$$f ( V ) = {\sum }_{( x , y ) ∈ Block in C} g ( N ( x - {V}_{x} , y - {V}_{y} ) - P ( x + {V}_{x} , y + {V}_{y} ) )$$
where
P(x+Vₓ,y+V_{y}) is a pixel in the previous reference frame offset according to the vector V=(Vₓ,V_{y});
N(x−Vₓ,y−V_{y}) is a pixel in the next reference frame offset according to the vector −V=(−Vₓ,−V_{y}).

10. A method according to claim 9, where said scaling functions g(e) is calculated as the absolute of e raised to a power x, where x is a positive number.

11. A method according to claim 10, where said power x is 1, which corresponds to the error functions f (in claim 9) being the commonly known sum of absolute differences (disregarding W(x,y)).

12. A method according to claim 10, where said power x is 2, which corresponds to the error functions f (in claim 9) being the commonly known sum of squared differences (disregarding W(x,y)).

13. A method according to claim 9, where said weights, W(x,y), applied to different pixels are in the range 0 to 1.

14. A method according to claim 13, where said weights, W(x,y), are defined through a user interaction in relation to knowledge about damages.

15. A method according to claim 14, where said user interaction comprises use of a paint brush having suitable shape, size and intensity.

16. A method according to claim 14, where said user interaction involves using an area selection tool, e.g. circle, rectangle, free form.

17. A method according to claim 13, where said weights, W(x,y), are defined through an automated detection method.

18. A method according to claim 17, comprising an automated method for determining W(x,y) using a confidence profile table or function related to the intensity of pixels in the source frame.

19. A method according to claim 17, where said automated method comprises analysis over several frames and which may include other conventional motion estimation methods.

20. A method according to claim 17, where said automated method comprises scanning procedures analyzing infrared properties of the film to acquire detailed and robust knowledge about damages.
